(19) United States
(12) Patent Application Publication
(10) Pub. No.: US 2004/0085510 A1
(43) Pub. Date: May 6, 2004

(54) Contact lenses for correction of irregular corneal surfaces

(76) Inventor: Keith T. O'Brien, Jacksonville, FL (US)

Correspondence Address: KEITH T. O'BRIEN, 7575 HOLLYRIDGE ROAD, JACKSONVILLE, FL, 32256, US

(21) Appl. No.: 10/283,379

(22) Filed: Oct. 30, 2002

(51) Int. Cl. G02C 7/04

(52) U.S. Cl. 351/160 R

(57) ABSTRACT

A contact lens is provided for correction of corneal distortions by provision of a low modulus hydrogel volume placed within the contact lens structure to overlay the pupil area and conform to corneal irregularities without print-through distorting the outer surface of the contact lens. The lenses thereby provide spherical, multifocal, astigmatic, and prismatic corrections without any requirement for orientation control. Corrections for conitis and corneal irregularities are also possible without the need for additional lens modifications. These lenses can also accommodate tear pumping, high oxygen transmission, edges off-the-eye, visibility tints and cosmetic tints.

### FIELD OF THE INVENTION

The present invention relates to a new design concept for contact lenses in the correction of vision problems due to irregular or misshapen corneal surfaces.

### BACKGROUND OF THE INVENTION

Soft contact lenses can be made by machining of an unhydrated hydrogel, spin casting as described in U.S. Pat. No. 3,408,429 or cast molding. These processes are given as illustrative and are not restricting to the invention. The present processes most compatible with this invention are spin casting and cast molding, but modifications to other process may be employed to achieve the product to be described. Hydrogel is a general term used in this application to cover materials which have compatibility with the eye, allow diffusion of oxygen, tears and other eye contact materials, and which have optical properties necessary to provide vision correction.

Spin casting of contact lenses is described in U.S. Pat. No. 4,517,138 and describes a process where polymerizable material is placed in a cupped mold which spins and spreads the polymerizable material by centrifugal force while it is subjected to polymerization conditions. The preform which results is then given final machining to produce a contact lens.

The cast molding of soft hydrophilic contact lenses is also known. Various processes are disclosed in U.S. Pat. Nos. 4,495,313, to Larsen; 4,640,489 to Larsen, 6,113,817 to Herbrectsmeier et al., and 6,039,913 to Hirt et al. These prior art references disclose a contact lens production process wherein each lens is formed by molding a reactive mixture, between a front curve (lower mold section) and back curve (upper mold section). The monomer injected into the molds is polymerized, thus forming a lens. The lens is removed from the mold and conditioned to a safe, wearable status by extraction, washing and conditioning stages prior to packaging for sale.

Contact lenses designed for use by patients with corneal deformities such as astigmatism have special features designed to minimize decentration and rotation since correct alignment of the contact lens on the eye is necessary for these types of correction to be satisfactory.

U.S. Pat. Nos. 3,831,604, 3,947,362 and others have disclosed that wearing hard contact lenses can be effective in reducing the detrimental effects of corneal deformities by physically smoothing out the corneal surfaces. There is no known prior art which details the same effects in the wearing of soft contact lenses.

U.S. Pat. No. 5,861,114 describes the complicated process required to design a contact lens for an astigmatic patient. Each lens is designed to fit one eye condition. U.S. Pat. No. 6,406,145 describes methods of improving centering and orientation control for contact lenses which are necessary for current contact lens designs to work with irregular corneal shapes.

In U.S. Pat. No. 6,196,685, Ross et. al. reveal that soft contact lenses have the characteristic of passing shapes from the back side of the lens to the front side of the lens. The irregular corneal shapes are transmitted to the adjacent lens surface, and then subsequently are transmitted to the alternate lens surface.

It is known that the modulus of hydrogels used to manufacture contact lenses can be modified by increasing or decreasing the amount of cross linking additives used or by adding other monomeric chemicals to the formulation which have a stiffer backbone. U.S. Pat. No. 4,355,147 is one example of such technology.

A soft contact lens can be considered as an optically clear deformable hydrogel sponge which changes the shape of the tear layer on the eye. This tear layer shape change by the hydrogel sponge provides a part of optical correction. The optical surface of the eye is that area through which light passes on its way to the retina and is generally directly external to the pupil. Adjacent in the context of this invention includes the presence of a tear film. The area adjacent the optical area of the eye is the main area of interest for this patent, but other design considerations which make a contact lens comfortable and wearable such as edge design and overall thickness are expected to be included in the overall design.

Alternate lens surfaces can provide spherical, multifocal, astigmatic, and prismatic corrections without any requirement for orientation control. Corrections for conitis and corneal irregularities can be provided in the adjacent surface.

Spherical correction lenses have been claimed and taught in U.S. Pat. Nos. 4,199,231 to Evans, 4,307,046 to Neefe, 4,564,484 to Neefe, 4,640,595 to Volk, 5,050,981 to Roffman, and 5,220,359 to Roffman. Background information is also contained in “Contact Lens Practice”, 4th Edition by Mandell, “Contact Lenses”, 3rd Edition by Phillips and Stone, and “Contact Lens Practice” by Ruben and Guillon. These corrections can be achieved in the lenses of the present invention through the shaping of the alternate lens surface.

Multifocal correction lenses have been claimed and taught in U.S. Pat. Nos. 4,162,122 to Cohen, 4,210,391 to Cohen, 4,338,005 to Cohen, 4,340,283 to Cohen, 5,050,981 to Roffman et al., 5,198,844 to Roffman et al., 5,448,312 to Roffman et al., 5,485,228 to Roffman et al., 5,512,220 to Roffman et al., 5,682,223 to Menezes et al., 5,715,031 to Roffman et al., 5,805,260 to Roffman et al., 5,835,192 to Roffman et al., 5,847,802 to Menezes et al., 5,929,969 to Roffman, and 6,196,685 to Roffman et al. Background information is also contained in “Contact Lens Practice”, 4th Edition by Mandell, “Contact Lenses”, 3rd Edition by Phillips and Stone, and “Contact Lens Practice” by Ruben and Guillon. These corrections can be achieved in the lenses of the present invention through the shaping of the alternate lens surface.

Astigmatic correction lenses have been claimed and taught in U.S. Pat. Nos. 4,573,774 to Sitterle, 4,324,461 to Salvatori, 5,016,977 to Baude et al., 5,020,898 to Townsley, 5,406,341 to Blum et al., 5,455,641 to Hahne et al., 5,570,143 to Newman, 5,650,837 to Roffman et al., 5,652,638 to Roffman et al., 5,796,462 to Roffman et al., and 5,805,260 to Roffman et al. Background information is also contained in “Contact Lens Practice”, 4th Edition by Mandell, “Contact Lenses”, 3rd Edition by Phillips and Stone, and “Contact Lens Practice” by Ruben and Guillon. These corrections can be achieved in the lenses of the present invention through the shaping of the alternate lens surface.

Prismatic correction lenses have been employed for many years although their use as contact lenses is somewhat limited. Some background information is contained in “Contact Lens Practice”, 4th Edition by Mandell, “Contact Lenses”, 3rd Edition by Phillips and Stone, and “Contact Lens Practice” by Ruben and Guillon. Prismatic corrections can be achieved in the lenses of the present invention through the shaping of the alternate lens surface.

Tear pumping lenses have been claimed and taught in U.S. Pat. Nos. 4,460,594 to Berger, 4,621,912 to Meyer, 4,666,267 to Wichterle, 4,866,350 to Wichterle, and 5,044,742 to Cohen. Background information is also contained in “Contact Lens Practice”, 4th Edition by Mandell, “Contact Lenses”, 3rd Edition by Phillips and Stone, and “Contact Lens Practice” by Ruben and Guillon. Although the tear pumping mechanisms vary, no mechanisms are known which could not be used with the present invention.

High oxygen transmission lenses, or more correctly lenses which do not reduce the transmission of oxygen to the eye so significantly, have been sought since physiological defects of the eye due to contact lens wearing was first observed. Background information on the physiological effects of contact lens wear is discussed in “Contact Lens Practice”, 4th Edition by Mandell, “Contact Lenses”, 3rd Edition by Phillips and Stone, and “Contact Lens Practice” by Ruben and Guillon. Although the high oxygen transmission mechanisms vary, no mechanisms are known which could not be used with the present invention.

Lenses with the edges off the eye have been claimed and taught in U.S. Pat. Nos. 4,017,238 to Robinson, 4,121,896 to Shepherd, 4,208,364 to Shepherd, 4,209,289 to Newcomb et al., 4,211,384 to Bourset et al., 4,284,399 to Newcomb et al., 4,865,779 to Ihn et al., 5,087,015 to Galley, and 5,149,052 to Stoy et al., and in G.B. Patent Nos. 2 216 065A to Galley, 2 230 730A to Sealey, 2 235 408A to Sealey et al., and in European Patent No. 0 255 535 to Seden et al. Background information is also contained in “Contact Lens Practice”, 4th Edition by Mandell, “Contact Lenses”, 3rd Edition by Phillips and Stone, and “Contact Lens Practice” by Ruben and Guillon. Although the edge off the eye designs may vary, no designs are known which could not be employed with the present invention.

Lenses with visibility tints have been claimed and taught in U.S. Pat. Nos. 4,252,421 to Foley, 4,468,229 to Su, 4,559,059 to Su, 4,640,805 to Neefe, 4,891,046 to Wittman, 5,059,018 to Kanome et al., 5,151,106 to Bhaumik et al., and 5,292,350 to Molock et al. Background information is also contained in “Contact Lens Practice”, 4th Edition by Mandell, “Contact Lenses”, 3rd Edition by Phillips and Stone, and “Contact Lens Practice” by Ruben and Guillon. These visibility tints can be achieved in the lenses of the present invention.

Lenses with cosmetic tints haver been claimed and taught in U.S. Pat. Nos. 4,252,421 to Foley, 4,460,523 to Neefe, 4,472,327 to Neefe, 4,553,975 to Su, 4,582,402 to Knapp, 4,639,105 to Neefe, 4,640,805 to Neefe, and 5,059,018 to Bhaumik et al. Background information is also contained in “Contact Lens Practice”, 4th Edition by Mandell, “Contact Lenses”, 3rd Edition by Phillips and Stone, and “Contact Lens Practice” by Ruben and Guillon. These cosmetic tints can be achieved in the lenses of the present invention.

U.S. Pat. No. 4,157,864 to Koller et al. claims and teaches a contact lens comprising at least two material components. The second material is a soft centering support around the periphery of the contact lens. U.S. Pat. No. 4,890,911 to Sulc et al. claims and teaches a contact lens comprising at least two material components. By using the specific design that is claimed some of the benefits of hard lenses are combined with some of the benefits of soft lenses, into a single lens. The methods of manufacturing such a lens are also claimed.

### SUMMARY OF THE INVENTION

The invention is a combination of the recognition of print through in soft contact lens material as described by Ross U.S. Pat. No. 6,196,685, and the fact that in relatively hard lens materials print through is not observed. In fact, it has been observed that contact lenses fabricated from relatively hard materials are known to reduce optical defects caused by irregular corneas due to mechanical smoothing.

The new concept is to provide a region of softer or more easily deformable contact lens material located adjacent to the pupil, or the optical area of the eye, while the materials forming the alternate lens surface and periphery of the contact lens are less deformable. In this manner the deformation which leads to print through occurs at the adjacent lens surface but not at the alternate lens surface.

The contact lens of this invention may have at least two distinct material moduli, the bulk of the lens forming the outer surface and the periphery being stiffer than the material adjacent the cornea over the pupil. Another option is for the contact lens to have a modulus gradient with the lower modulus material adjacent the cornea. The moduli differences may be discrete or gradual. Contact lens materials are usually hydrogels and will be referred to as such, even though other cellular sponge like materials may be used. Astigmatism will be used to mean corneal irregularities resulting in poor vision.

The result is that corneal deformities of the optical region of the eye will be accommodated by deformation of the low modulus hydrogel adjacent the optical area of the cornea while the stiffer outer and peripheral hydrogel material of the contact lens will tend to retain its spherical form. The result is a contact lens that corrects for astigmatism, conitis and corneal irregularities of the eye and that is not required to be orientation controlled to the extent now necessary for acceptable vision correction. More simply put, the invention is a contact lens which accommodates corneal irregularities at its adjacent surface while not distorting at its alternate surface.

What is disclosed is a contact lens that provides optical correction for corneal deformities by having a physical design with a lower modulus hydrogel material adjacent the optical surface of the eye and at least some more rigid hydrogel material forming the remaining structure of the contact lens. The lower modulus material will comprise less than 70% of the contact lens by volume. Spherical, multifocal, toric, prismatic, tear pumping, high oxygen transmission, visibility tinted, and cosmetic tinted lenses as well as combinations of these lens types may all be provided under the present invention.

### BRIEF DESCRIPTION OF THE DRAWINGS

Other objects and advantages of the present invention will become more apparent upon reference to the following specification and annexed drawings in which:

FIG. 1 shows a current contact lens shape which has the same modulus material throughout.

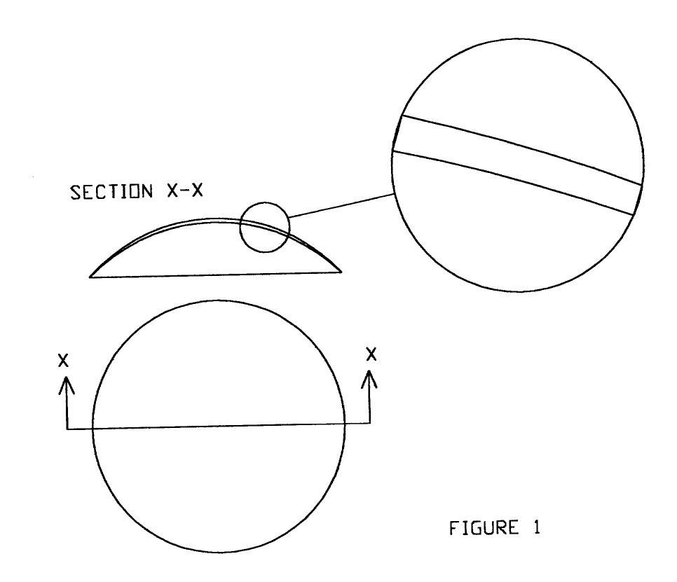

FIG. 2 has a lower modulus material located on the inner central part of the lens and shown by arrow A and has a relatively abrupt modulus change to a higher modulus material on the outer surface of the lens as shown by arrow B.

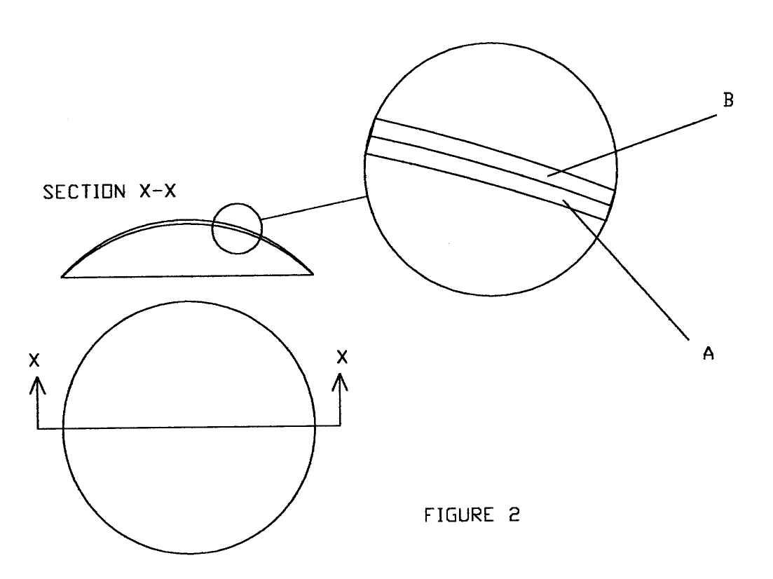

FIG. 3 has a lower modulus material located on the inner central part of the lens and shown by arrow C and has a gradual increase of modulus from the inner surface to a higher modulus material on the outer surface of the lens as shown by arrow D.

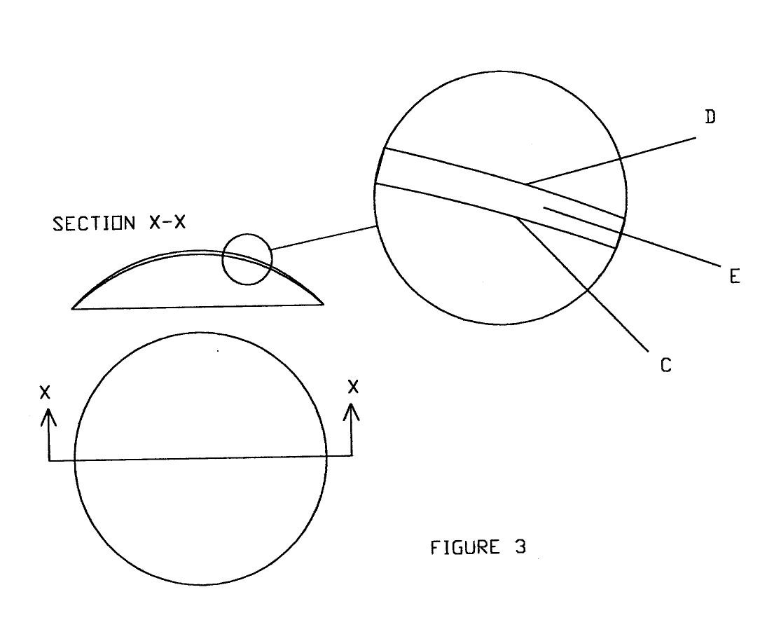

FIG. 4 illustrates how the lens changes shape from the passive to the active positions.

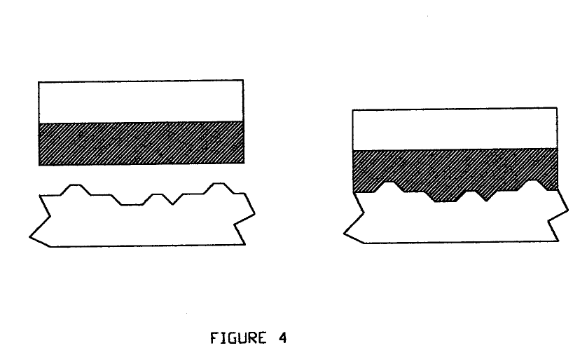

FIG. 5 shows the lower modulus material, denoted by arrow E, encapsulated by the higher modulus material, denoted by arrow F, on all sides except the surface adjacent to the eye.

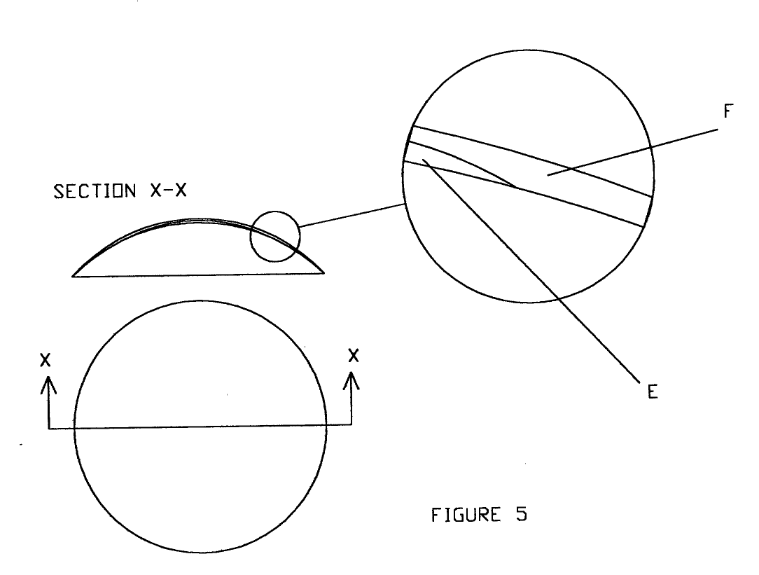

FIG. 6 shows a first material with a lower modulus, denoted by arrow G, encapsulated by a second material with a higher modulus, denoted by arrow H, on all sides except the surface adjacent to the eye. The second material is encapsulated by a third material with a higher modulus, denoted by arrow I, on all sides except the surface adjacent to the first material. The third material with a higher modulus, denoted by arrow J, on all sides except the surface adjacent to the second material is encapsulated by a fourth material with a higher modulus, denoted by arrow K, on all sides except the surface adjacent to the second material.

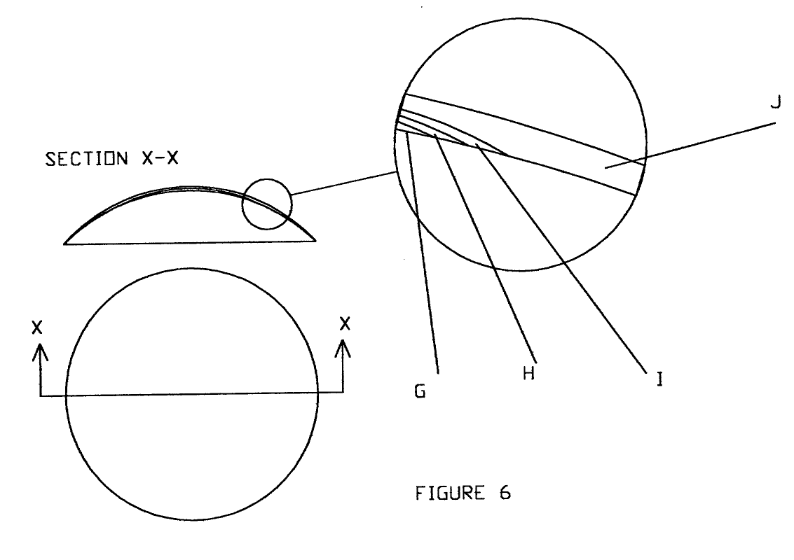

### DETAILED DESCRIPTION OF THE INVENTION

The invention works by having a contact lens with a deformable, lower modulus hydrogel surface adjacent the eye and a less deformable higher modulus material in the outer portions of a contact lens. The near/far correction shape or profile will normally be on the contact lens surface away from the cornea. The astigmatism correction can occur by the low modulus material adjacent the cornea accommodating the irregular corneal surfaces by expansion or compression while the higher modulus material at the exterior surface of the lens maintains its designed shape. The modulus change may be abrupt or gradual. The alternate surface can provide spherical, multifocal and prismatic corrections, whereas the adjacent surface can provide toric, conitis and corneal irregularity corrections. The volume of a product hydrogel contact lens is about 30 microliters, about half of which is a tear compatible liquid or saline solution. The shape of a contact lens is approximately a shell or circular concave/convex shape formed by the intersection of two spheres of different radius. The radius of one sphere will be that of the target market eye, or about 8 mm and the disk diameter will be about 14 mm. When the finished product contact lens is placed upon the eye, the low modulus material will contact the corneal surfaces where the irregularities are present and either expand into depressions or be compressed by elevations. The high modulus material forming the outer volume of the optical area will resist deformation and substantially retain its spherical correction properties. When these contact lenses are placed upon the eye of the user, the normal modulus material in the outer parts of the contact lens will resist the print through effect and retain most of the desired optical shape. The soft, low modulus material will distort to accommodate the problem shapes of the cornea, but not sufficiently to cause the print through effect. Movement of the contact lens on the eye will not result in significant optical problems due to this accommodation property. This will result in significantly reduced problems resulting from centration and rotation changes which are normal happenings due to eye movement and blinking.

For the abrupt modulus change process, at least two hydrogel forming formulations will be prepared, one high modulus material producing prepolymer or monomer mix to form the bulk of the contact lens which will be called the base modulus material and one lower modulus producing prepolymer or monomer mix to form the pupil covering surface of the contact lens. The base modulus material may be the same as is currently used by one of the several contact lens production processes or it may be produced to be slightly firmer by addition of more crosslinkers. By low modulus producing is meant that the modulus of the resulting polymer will be less than the modulus of the surface of the eye. This will be achieved by methods well known in the art such as modified cross linker levels or addition of softer or stiffer monomer or prepolymer components to one or both of the materials used. These materials will be designed to polymerize together at their interface and have similar expansion and shrinkage properties. It is expected that this differentiation of materials will not be major, with crosslinker concentration changes between the two materials expected to be the most often used method to produce the necessary modulus changes.

For cast molding, the high modulus forming material may be placed in the female casting mold first, followed by addition of the required low modulus forming material. The low modulus forming material will be carefully metered and placed precisely over the area to form the inner optical zone of the lens. As the low modulus material is added, it will displace the higher modulus producing liguid prepolymer or monomer below its addition point. The mold will then be closed by placement of the male mold half upon the female mold half as is well known in the art. Some further spreading of the low modulus material will occur as a result of mold closing, but this spreading will be repeatable and may be designed into the placement and quantity specifications for low modulus material. As a variation to the method, the low modulus forming material may be placed upon the male mold prior to its being assembled to the female mold.

In a typical cast molding process for producing the contact lens of this invention, the normal monomer charge minus the volume for the low modulus material would be placed into the female mold. Then a volume of about 0.0025 cubic centimeters (2.5 microliters) of low modulus forming material is carefully placed over the material in the optical center of the mold. This will displace the base modulus material. The volume of low modulus material is designed to produce a zone within the lens that occupies the volume over the pupil area with a thickness of about half the contact lens thickness. A typical size for this low modulus volume would be a circular disk with a diameter of about 7 mm and a thickness of 50 microns. The male mold is then mated to the female mold in the normal manner. This mating action results in spreading of the low modulus forming material into a disk like profile on the eye contacting side of the unpolymerized material within the contact lens mold. The closed and mated mold is then subjected to the normal production process. The resulting contact lens will have the shape and properties of other contact lenses with the exception of the more surface accommodating properties adjacent the cornea in the eye optical zone. The steps and volumes described are illustrative only and not meant to be restrictive.

A similar method would be to charge the concave lens mold component with the lens forming material that polymerizes to form the high modulus alternate surface. Then a convex lens mold component could be assembled to the charged concave lens mold component to shape the lens forming material. Then the convex lens mold component could be removed, and a charge of the lens forming material that polymerizes to form the low modulus adjacent surface could be added to the charged concave mold component. Then a different convex lens mold component could be assembled to the doubly charged lens mold component. The lens forming materials could then be polymerized.

A variation of this method of forming the contact lens would be to manufacture the convex surface of the lens which is the high modulus material surface with a concave back and cast the low modulus lens forming material into the back, shape it with a lens mold component, cure it, and demold the resultant lens.

Alternate ways to get the low modulus forming material into this position would be to apply the low modulus material to the male mold by printing or dipping and then assembling the male and female molds.

For spin casting, the procedure will be very similar. The low modulus forming material will be carefully metered onto the central surface of the high modulus forming material which had been previously added to the spin casting mold. The spin casting process will then be started. Both materials will spread about the axis of rotation with the low modulus forming monomer volume centered over the central inner optical zone.

Spin casting could be done by a manner similar to the first description, but using the centrifugal forces to spread the low modulus forming material into a flattened disk for polymerization.

The volume and modulus properties may be changed to achieve the desired result as will be evident to those skilled in the art. These changes would be expected when one considers the properties of the many materials currently used to produce contact lenses.

A gradual modulus change could be achieved by sequential injections of material with different crosslinker concentrations into the mold with the formulation designed to produce the lower modulus injected last in a cast molding operation. Another way to achieve a more gradual modulus change would be to have a material with low crosslinker concentration injected onto the back side of the lens material with higher crosslinker concentration, closing the casting mold, and waiting for diffusion of crosslinker from the higher concentration material to produce the crosslinker pattern necessary to obtain a modulus gradient when the materials are polymerized.

Other process steps may be used to produce these lenses, but a contact lens with a surface adjacent the optical surface of the cornea capable of deformation without or with reduced print through onto the exterior surface of the lens is the primary invention to be claimed. The processes by which the lens of the claimed invention is fabricated is secondary.

What is claimed is:

1. A contact lens comprising,
an alternate surface which retains its shape, and,
an adjacent surface which conforms to the geometric surface of the eye and provides at least one optical correction.

2. The contact lens of claim 1 wherein at least one optical correction of said alternate surface is provided.

3. The contact lens of claim 2 wherein said at least one optical correction of said alternate surface is at least one from the group of plano, spherical, multifocal, toric and prismatic, and said at least one optical correction of said second surface is at least one from the group of plano, toric, conitis and corneal irregularities.

4. The contact lens of claim 1 wherein said lens is provided with at least one from the group comprising a means to pump tears between the lens and the eye, a means to pump tears between the lens and the eyelid, a means to improve oxygen transmission to the eye, a means to ensure that the lens edge does not significantly contact the eye, a visibility tint and a cosmetic tint.

5. The contact lens of claim 2 wherein said lens is provided with at least one from the group comprising a means to pump tears between the lens and the eye, a means to pump tears between the lens and the eyelid, a means to improve oxygen transmission to the eye, a means to ensure that the lens edge does not significantly contact the eye, a visibility tint and a cosmetic tint.

6. The contact lens of claim 3 wherein said lens is provided with at least one from the group comprising a means to pump tears between the lens and the eye, a means to pump tears between the lens and the eyelid, a means to improve oxygen transmission to the eye, a means to ensure that the lens edge does not significantly contact the eye, a visibility tint and a cosmetic tint.

7. The contact lens of claim 1 wherein said lens comprises at least two materials with different viscoelastic moduli.

8. The contact lens of claim 2 wherein said lens comprises at least two materials with different viscoelastic moduli.

9. The contact lens of claim 3 wherein said lens comprises at least two materials with different viscoelastic moduli.

10. The contact lens of claim 4 wherein said lens comprises at least two materials with different viscoelastic moduli.

11. The contact lens of claim 5 wherein said lens comprises at least two materials with different viscoelastic moduli.

12. The contact lens of claim 6 wherein said lens comprises at least two materials with different viscoelastic moduli.

13. The contact lens of claim 7 wherein said at least two materials with different viscoelastic moduli are arranged such that one material with the highest viscoelastic modulus comprises at least forty percent of the lens volume.

14. The contact lens of claim 8 wherein said at least two materials with different viscoelastic moduli are arranged such that one material with the highest viscoelastic modulus comprises at least forty percent of the lens volume.

15. The contact lens of claim 9 wherein said at least two materials with different viscoelastic moduli are arranged such that one material with the highest viscoelastic modulus comprises at least forty percent of the lens volume.

16. The contact lens of claim 10 wherein said at least two materials with different viscoelastic moduli are arranged such that one material with the highest viscoelastic modulus comprises at least forty percent of the lens volume.

17. The contact lens of claim 11 wherein said at least two materials with different viscoelastic moduli are arranged such that one material with the highest viscoelastic modulus comprises at least forty percent of the lens volume.

18. The contact lens of claim 12 wherein said at least two materials with different viscoelastic moduli are arranged such that one material with the highest viscoelastic modulus comprises at least forty percent of the lens volume.

19. The contact lens of claim 7 wherein said at least two materials with different viscoelastic moduli are arranged such that one material with the lowest viscoelastic modulus overlays the pupil of the eye.

20. The contact lens of claim 8 wherein said at least two materials with different viscoelastic moduli are arranged such that one material with the lowest viscoelastic modulus overlays the pupil of the eye.

21. The contact lens of claim 9 wherein said at least two materials with different viscoelastic moduli are arranged such that one material with the lowest viscoelastic modulus overlays the pupil of the eye.

22. The contact lens of claim 10 wherein said at least two materials with different viscoelastic moduli are arranged such that one material with the lowest viscoelastic modulus overlays the pupil of the eye.

23. The contact lens of claim 11 wherein said at least two materials with different viscoelastic moduli are arranged such that one material with the lowest viscoelastic modulus overlays the pupil of the eye.

24. The contact lens of claim 12 wherein said at least two materials with different viscoelastic moduli are arranged such that one material with the lowest viscoelastic modulus overlays the pupil of the eye.

25. The contact lens of claim 7 wherein said one material with the lowest viscoelastic modulus is surrounded by at least one material with a higher viscoelastic modulus.

26. The contact lens of claim 8 wherein said one material with the lowest viscoelastic modulus is surrounded by at least one material with a higher viscoelastic modulus.

27. The contact lens of claim 9 wherein said one material with the lowest viscoelastic modulus is surrounded by at least one material with a higher viscoelastic modulus.

28. The contact lens of claim 10 wherein said one material with the lowest viscoelastic modulus is surrounded by at least one material with a higher viscoelastic modulus.

29. The contact lens of claim 11 wherein said one material with the lowest viscoelastic modulus is surrounded by at least one material with a higher viscoelastic modulus.

30. The contact lens of claim 12 wherein said one material with the lowest viscoelastic modulus is surrounded by at least one material with a higher viscoelastic modulus.

31. The contact lens of claim 7 wherein said one material with the lowest viscoelastic modulus penetrates corneal depressions and is penetrated by corneal asperities, while said one material with the highest viscoelastic modulus exhibits no significant distortion.

32. The contact lens of claim 8 wherein said one material with the lowest viscoelastic modulus penetrates corneal depressions and is penetrated by corneal asperities, while said one material with the highest viscoelastic modulus exhibits no significant distortion.

33. The contact lens of claim 9 wherein said one material with the lowest viscoelastic modulus penetrates corneal depressions and is penetrated by corneal asperities, while said one material with the highest viscoelastic modulus exhibits no significant distortion.

34. The contact lens of claim 10 wherein said one material with the lowest viscoelastic modulus penetrates corneal depressions and is penetrated by corneal asperities, while said one material with the highest viscoelastic modulus exhibits no significant distortion.

35. The contact lens of claim 11 wherein said one material with the lowest viscoelastic modulus penetrates corneal depressions and is penetrated by corneal asperities, while said one material with the highest viscoelastic modulus exhibits no significant distortion.

36. The contact lens of claim 12 wherein said one material with the lowest viscoelastic modulus penetrates corneal depressions and is penetrated by corneal asperities, while said one material with the highest viscoelastic modulus exhibits no significant distortion.

37. The contact lens of claim 1 wherein there is a gradient of viscoelastic moduli from said first surface to said second surface.

38. The contact lens of claim 2 wherein there is a gradient of viscoelastic moduli from said first surface to said second surface.

39. The contact lens of claim 3 wherein there is a gradient of viscoelastic moduli from said first surface to said second surface.

40. The contact lens of claim 4 wherein there is a gradient of viscoelastic moduli from said first surface to said second surface.

41. The contact lens of claim 5 wherein there is a gradient of viscoelastic moduli from said first surface to said second surface.

42. The contact lens of claim 6 wherein there is a gradient of viscoelastic moduli from said first surface to said second surface.

43. The method of manufacture of the contact lens of claims 1 through 42 comprising the steps of,
dispensing a first metered charge of lens forming material into a concave lens mold component,
dispensing a second metered charge of lens forming material adjacent to the first metered charge of lens forming material,
assembling a convex lens mold component to the charged concave lens mold component,
curing the first and second lens forming materials to form a composite lens with
at least two different viscoelastic moduli, and,
removing the concave lens mold component and the convex lens mold component.

44. The method of manufacture of the contact lens of claims 1 through 42 comprising the steps of,
dispensing a first metered charge of lens forming material into a concave lens mold component,
assembling a convex lens mold component to the charged concave lens mold component,
dispensing a second metered charge of lens forming material adjacent to the first metered charge of lens forming material,
assembling a different convex lens mold component to the charged concave lens mold component,
curing the first and second lens forming materials to form a composite lens with
at least two different viscoelastic moduli, and, removing the concave lens mold component and the convex lens mold component.

45. The method of manufacture of the contact lens of claims 1 through 42 comprising the steps of,
dispensing a first metered charge of lens forming material into a concave lens mold component,
rotating the charged concave lens mold component to distribute the first metered charge of lens forming material,
dispensing a second metered charge of lens forming material adjacent to the first metered charge of lens forming material,
rotating the charged concave lens mold component to distribute the second metered charge of lens forming material,
assembling a convex lens mold component to the charged concave lens mold component,
curing the first and second lens forming materials to form a composite lens with at least two different viscoelastic moduli, and,
removing the concave lens mold component and the convex lens mold component.

46. The method of manufacture of the contact lens of claims 1 through 42 comprising the steps of,
forming the alternate surface with the high modulus in a substantially spherical shell,
dispensing a metered charge of lens forming material into the concave side of the shell,
assembling a convex lens mold component to the metered charge of lens forming material,
curing the lens forming material, and,
removing the convex lens mold component

47. The method of manufacture of the contact lens of claims 1 through 6, and claims 37 through 42 comprising the steps of,
dispensing a metered charge of lens forming material into a concave lens mold component,
assembling a convex lens mold component to the charged concave lens mold component,
curing the lens forming material preferentially to create a viscoelastic modulus gradient in the cured lens, and,
removing the concave lens mold component and the convex lens mold component.
